(19) United States
(12) Patent Application Publication
(10) Pub. No.: US 2022/0323929 A1
(43) Pub. Date: Oct. 13, 2022

(54) MODIFIED ZEOLITE FOR HEAVY METAL REMOVAL

(71) Applicant: OMYA INTERNATIONAL AG, Oftringen (CH)

(72) Inventors: Tobias KELLER, Gränichen (CH); Samuel RENTSCH, Spiegel bei Bern (CH)

(73) Assignee: OMYA INTERNATIONAL AG, Oftringen (CH)

(21) Appl. No.: 17/629,582

(22) PCT Filed: Aug. 18, 2020
(86) PCT No.: PCT/EP2020/073128

§ 371 Date: Jan. 24, 2022

(30) Foreign Application Priority Data
Aug. 22, 2019 (EP) 19193114.6

(51) Int. Cl. B01J 20/18; B01J 20/28; C02F 1/28

(52) U.S. Cl. CPC B01J 20/186; B01J 20/28052; B01J 20/28007; B01J 20/28016; B01J 20/28059; B01J 20/28061; C02F 1/281; C02F 2101/20

(57) ABSTRACT

The present invention relates to the use of particulate mineral material comprising modified heulandite group zeolite for removing heavy metal cations from a liquid medium, wherein at least a part of the exchangeable cations in the heulandite group zeolite is replaced by ammonium cations.

The present invention relates to the treatment of effluents containing heavy metals, and in particular to the use of a particulate mineral material comprising modified zeolite of the heulandite group for removing heavy metal cations from a liquid medium, as well as a corresponding method and system for removing heavy metal cations from a liquid medium.

Many industries discharge large amounts of metal-contaminated effluents such as sludge, wastewater, or tailings bearing heavy metals, such as Pb, Zn, Mn, Cd, Cu, Mo, Co, Hg, or Ni. Because of their high solubility in aqueous mediums and since heavy metal ions are non-biodegradable, they can be absorbed by living organisms. Once they enter the food chain, large concentrations of heavy metals may accumulate in the human body. If the metals are ingested beyond the permitted concentration, they can cause serious health disorders. Serious health effects include reduced growth and development, cancer, organ damage, nervous system damage, and in extreme cases, death. Exposure to some metals, such as mercury and lead, may also cause development of autoimmunity, in which a person's immune system attacks its own cells. This can lead to joint diseases such as rheumatoid arthritis, and diseases of the kidneys, circulatory system, nervous system, and damaging of the fetal brain. At higher doses, heavy metals can cause irreversible brain damage. Another heavy metal, which deserves high attention is cadmium. Cd is employed in numerous industrial applications, mainly linked to the metallurgy industry and causes damages inter alia to the respiratory system, the kidneys and the skeletal system.

Wastewater streams containing heavy metals are produced from different industries. For example, electroplating and metal surface treatment processes generate significant quantities of wastewaters containing heavy metals. Other sources for metal wastes include the wood processing industry, where arsenic-containing wastes are produced, and the petroleum refining which generates conversion catalysts contaminated with chromium. All of these and other industries produce a large quantity of wastewaters and sludges that requires extensive waste treatment.

Wastewater regulations were established to minimize human and environmental exposure to hazardous chemicals. This includes limits on the types and concentration of heavy metals that may be present in the discharged wastewater. Therefore, it is necessary to remove or minimize the heavy metal ions in wastewater systematically by treating metal-contam rinated wastewater prior to its discharge to the environment.

Principally, several methods for the heavy metal removal from a metal-contaminated aqueous medium are known in the art. The conventional processes for removing heavy metals from wastewater include e.g. chemical precipitation, flotation, adsorption, ion exchange and electrochemical deposition. Ion exchange is another method being used in the industry for the removal of heavy metals from waste water or sludges. Electrolytic recovery or electro-winning is another technology used to remove metals from process water streams. This process uses electricity to pass a current through an aqueous metal-bearing solution containing a cathode plate and an insoluble anode. Positively charged metallic ions cling to the negatively charged cathodes leaving behind a metal deposit that is strippable and recoverable.

Over the last years and decades, environmental regulations have become more and more stringent, requiring an improved quality of treated effluent. Therefore, many of the known methods may no longer be efficient enough or are too costly due to the technique or the materials employed for the removal below the required level.

Although, many functionalized materials are known in the art, these materials are often designed for other purposes or are used in other fields. Exemplarily, reference is made to EP 3 192 839 A1, which describes a process for the surface-treatment of a calcium carbonate-comprising material, which involves the adjustment of the pH-value of an aqueous suspension of at least one calcium carbonate-comprising material to a range from 7.5 to 12 and the addition of at least one surface-treatment agent to the aqueous suspension. Said surface-treatment agent is a silane compound as specified in EP 3 192 839 A1.

For completeness, the applicant would like to mention the unpublished patent application with filing number 18 185 361.5 in his name, relating to the use of a particulate mineral material being functionalized with one or more adsorption enhancing agents for scavenging and removing ionic metal contaminants from an aqueous medium, and the unpublished patent application with filing number 18 185 358.1 in his name, relating to the use of a particulate material being functionalized with one or more scavenging agents for scavenging and removing cationic metal ions from an aqueous medium.

In view of the foregoing, there is an ongoing need for the development of new efficient treatment technologies, which allow for the treatment of effluents containing heavy metals.

Accordingly, it is an object of the present invention to provide an agent that can be used in the treatment of effluents and/or process water containing heavy metals. It would be desirable that said agent provides a high removal performance for a broad range of heavy metals, and is especially effective in the removal of mercury. It would also be desirable to use an agent, which is at least partially derivable from natural sources, is environmentally benign and inexpensive.

It is also an object of the present invention to provide an economic method for removing heavy metal cations from wastewater. It would be desirable to provide a method which requires no or only limited technical equipment for carrying out the same. It would also be desirable to provide a process which can remove heavy metals without altering the pH of the effluent.

The foregoing and other objects are solved by the subject-matter as defined in the independent claims.

According to one aspect of the present invention, use of particulate mineral material comprising modified heulandite group zeolite for removing heavy metal cations from a liquid medium is provided, wherein at least a part of the exchangeable cations in the heulandite group zeolite is replaced by ammonium cations.

According to another aspect of the present invention, a method for removing heavy metal cations from a liquid medium is provided, the method comprising the steps of:

a) providing a liquid medium containing heavy metal cations,

b) providing a particulate mineral material comprising modified heulandite group zeolite, wherein at least a part of the exchangeable cations in the heulandite group zeolite is replaced by the ammonium cations,

c) contacting the particulate mineral material of step b) with the liquid medium of step a) to remove heavy metal cations from the liquid medium by forming a heavy metal loaded particulate mineral material.

According to still another aspect of the present invention, a system for removing heavy metal cations from a liquid medium is provided, the system comprising a reactor, wherein the reactor comprises

an inlet for a liquid medium containing heavy metal cations,

particulate mineral material comprising modified heulandite group zeolite, wherein at least a part of the exchangeable cations in the heulandite group zeolite is replaced by ammonium cations, and

an outlet for heavy metal cation depleted liquid medium.

Advantageous embodiments of the present invention are defined in the corresponding subclaims.

According to one embodiment the liquid medium is an aqueous medium, preferably the aqueous medium is selected from process water, sewage water, waste water, preferably waste water from the paper industry, waste water from the colour-, paints-, or coatings industry, waste water from breweries, waste water from the leather industry, agricultural waste water, slaughterhouse waste water, process or waste water from power plants, waste water from waste incineration, waste water from mercury recycling, waste water from cement production, waste water from steel production, waste water from production of fossil fuels, from sludge, preferably sewage sludge, harbour sludge, river sludge, coastal sludge, digested sludge, mining sludge, municipal sludge, civil engineering sludge, sludge from oil drilling or the effluents the aforementioned dewatered sludges.

According to one embodiment at least 70% of the exchangeable cations in the heulandite group zeolite are replaced by ammonium cations, preferably at least 90% of the exchangeable cations in the heulandite group zeolite are replaced by ammonium cations, more preferably at least 95% of the exchangeable cations in the heulandite group zeolite are replaced by ammonium cations, and most preferably all exchangeable cations in the heulandite group zeolite are replaced by ammonium cations. According to a further embodiment the heulandite group zeolite is clinoptilolite. According to still a further embodiment the particulate mineral material has a weight median particle size d50 from 0.05 to 500 μm, preferably from 0.2 to 200 μm, more preferably from 0.4 to 100 μm, and most preferably from 0.6 to 20 μm, and/or a weight top cut particle size d98 from 0.15 to 1500 μm, preferably from 1 to 600 μm, more preferably from 1.5 to 300 μm, and most preferably from 2 to 80 μm.

According to one embodiment, the particulate mineral material has a weight median particle size d50 from 0.05 to 100 μm, preferably from 0.05 to 20 μm, more preferably from 0.2 to 100 μm, even more preferably from 0.2 to 20 μm, and most preferably from 0.4 to 20 μm. According to a further embodiment, the particulate mineral material has a weight top cut particle size d98 from 0.15 to 300 μm, preferably from 0.15 to 80 μm, more preferably from 1 to 300 μm, even more preferably from 1 to 80 μm, and most preferably from 1.5 to 80 μm.

According to one embodiment the surface of the particulate mineral material is free of halogen compounds, preferably free of halogen compounds selected from the group consisting of chlorides, chlorates, hypochlorites, bromides, bromates, hypobromites, iodides, iodates, hypoiodites, and mixtures thereof, and most preferably free of halogen compounds selected from the group consisting of bromine, chlorine, iodine, sodium bromide, calcium bromide, magnesium bromide, copper (II) bromide, iron (II) bromide, iron (III) bromide, zinc bromide, potassium bromide, copper (I) chloride, copper (II) chloride, iron (II) chloride, iron (III) chloride, zinc chloride, calcium hypochlorite, calcium hypobromite, calcium hypoiodite, calcium chloride, calcium iodide, magnesium chloride, magnesium iodide, sodium chloride, sodium iodide, potassium tri-chloride, potassium tri-bromide, potassium tri-iodide, or mixtures thereof.

According to one embodiment the particulate mineral material has a specific surface area of from 5 m2/g to 200 m2/g, preferably from 10 m2/g to 180 m2/g, more preferably from 20 m2/g to 170 m2/g, even more preferably from 25 m2/g to 150 m2/g, and most preferably from 30 m2/g to 120 m2/g, measured using nitrogen sorption and the BET method. According to a further embodiment the particulate mineral material has a specific surface area of from 20 m2/g to 200 m2/g, preferably from 25 m2/g to 200 m2/g, more preferably from 30 m2/g to 200 m2/g, even more preferably from 25 m2/g to 180 m2/g, and most preferably from 25 m2/g to 120 m2/g, measured using nitrogen sorption and the BET method. According to a further embodiment the heavy metal cations are selected from the group consisting of arsenic, cadmium, chromium, cobalt, copper, gold, iron, lead, manganese, mercury, molybdenum, nickel, silver, tin, zinc, or mixtures thereof, preferably the heavy metal cations are selected from the group consisting of cadmium, copper, lead, mercury, zinc, or mixtures thereof, more preferably the heavy metal cations are selected from the group consisting of copper, lead, mercury, or mixtures thereof, and most preferably the heavy metal cations are mercury cations. According to still a further embodiment the use is performed in a system for removing heavy metal cations from a liquid medium comprising a reactor, wherein the reactor comprises an inlet for the liquid medium containing heavy metal cations, the particulate mineral material comprising modified heulandite group zeolite, and an outlet for heavy metal cation depleted liquid medium.

According to one embodiment the particulate mineral material of step b) is prepared by a method comprising the steps of:

i) providing a particulate heulandite group zeolite source material, wherein the heulandite group zeolite comprises exchangeable cations,

ii) providing an aqueous solution comprising at least one water-soluble ammonium salt,

iii) treating the particulate heulandite group zeolite source material of step i) with the aqueous solution of step ii) to form particulate mineral material comprising modified heulandite group zeolite, wherein at least a part of the exchangeable cations in the heulandite group zeolite is replaced by the ammonium cations of the water-soluble ammonium salt.

According to one embodiment the at least one water-soluble ammonium salt of step ii) is selected from ammonium nitrate, ammonium chloride, ammonium bromide, ammonium iodide, ammonium perchlorate, ammonium hydroxide, ammonium carbonate, ammonium sulfate, ammonium phosphate, or mixtures thereof, preferably the at least one water-soluble ammonium salt is ammonium nitrate. According to a further embodiment the at least one water-soluble ammonium salt of step ii) is provided in an amount so that the amount of ammonium cations in the water-soluble ammonium salt is from 0.05 to 20 wt.-%, based on the total weight of the particulate mineral material, preferably in an amount from 0.25 to 7.5 wt.-%, more preferably in an amount from 0.5 to 4 wt.-%, and most preferably in an amount from 1 to 3 wt.-%.

According to one embodiment the aqueous solution comprising the at least one water-soluble ammonium salt of step ii) has an ammonium cation concentration from 0.001 to 20 mol/1, preferably from 0.01 to 15 mol/1, more preferably from 1 to 7.5 mol/1, and most preferably from 2 to 5 mol/1. According to another embodiment the method further comprises a step d) of removing the heavy metal loaded particulate mineral material from the liquid medium after step c), preferably step d) is performed by filtration, centrifugation, sedimentation, or flotation. According to still a further embodiment, the method is performed in a system for removing heavy metal cations from a liquid medium comprising a reactor, wherein the reactor comprises an inlet for the liquid medium containing heavy metal cations, the particulate mineral material comprising modified heulandite group zeolite, and an outlet for heavy metal cation depleted liquid medium.

According to one embodiment the reactor contains the particulate mineral material in form of pellets and/or the particulate mineral material is provided in form of a bed or column.

It should be understood that for the purpose of the present invention, the following terms have the following meaning:

Unless specified otherwise, the term “drying” refers to a process according to which at least a portion of water is removed from a material to be dried such that a constant weight of the obtained “dried” material at 200° C. is reached. Moreover, a “dried” or “dry” material may be defined by its total moisture content which, unless specified otherwise, is less than or equal to 10.0 wt.-%, preferably less than or equal to 5 wt.-%, more preferably less than or equal to 2 wt.-%, and most preferably between 0.3 and 0.7 wt.-%, based on the total weight of the dried material.

A “mineral” in the meaning of the present invention encompasses a solid inorganic substance having a characteristic chemical composition.

The term “particulate” in the meaning of the present document refers to materials composed of a plurality of particles. Said plurality of particles may be defined, for example, by its particle size distribution (d98, d50 etc.).

The “particle size” of particulate materials, for example, particulate mineral material comprising modified heulandite group zeolite, is described by its weight-based distribution of particle sizes dx. Therein, the value dx represents the diameter relative to which x % by weight of the particles have diameters less than dx. This means that, for example, the d20 value is the particle size at which 20 wt.-% of all particles are smaller than that particle size. The d50 value is thus the weight median particle size, i.e. 50 wt.-% of all particles are smaller than this particle size. For the purpose of the present invention, the particle size is specified as weight median particle size d50 (wt) unless indicated otherwise. Particle sizes were determined by using a Sedigraph™ 5100 instrument or Sedigraph™ 5120 instrument of Micromeritics Instrument Corporation. The method and the instrument are known to the skilled person and are commonly used to determine the particle size of fillers and pigments. The measurements were carried out in an aqueous solution of 0.1 wt.-% Na4P2O7.

The “specific surface area” (expressed in m2/g) of a material as used throughout the present document can be determined by the Brunauer Emmett Teller (BET) method with nitrogen as adsorbing gas and by use of a ASAP 2460 instrument from Micromeritics. The method is well known to the skilled person and defined in ISO 9277:2010. Samples are conditioned at 300° C. under vacuum for a period of 1 h prior to measurement. The total surface area (in m2) of said material can be obtained by multiplication of the specific surface area (in m2/g) and the mass (in g) of the material.

For the purpose of the present invention, the “solids content” of a liquid composition is a measure of the amount of material remaining after all the solvent or water has been evaporated. If necessary, the “solids content” of a suspension given in wt.-% in the meaning of the present invention can be determined using a Moisture Analyzer HR73 from Mettler-Toledo (T=120° C., automatic switch off 3, standard drying) with a sample size of 5 to 20 g.

A “solution” as referred to herein is understood to be a single phase mixture of a specific solvent and a specific solute, for example a single phase mixture of a water-soluble salt and water. The term “dissolved” as used herein thus refers to the physical state of a solute in a solution.

A “suspension” or “slurry” in the meaning of the present invention comprises undissolved solids and water, and optionally further additives, and usually contains large amounts of solids and, thus, is more viscous and can be of higher density than the liquid from which it is formed.

Where an indefinite or definite article is used when referring to a singular noun, e.g., “a”, “an” or “the”, this includes a plural of that noun unless anything else is specifically stated.

Where the term “comprising” is used in the present description and claims, it does not exclude other elements. For the purposes of the present invention, the term “consisting of” is considered to be a preferred embodiment of the term “comprising”. If hereinafter a group is defined to comprise at least a certain number of embodiments, this is also to be understood to disclose a group, which preferably consists only of these embodiments.

Terms like “obtainable” or “definable” and “obtained” or “defined” are used interchangeably. This, for example, means that, unless the context clearly dictates otherwise, the term “obtained” does not mean to indicate that, for example, an embodiment must be obtained by, for example, the sequence of steps following the term “obtained” though such a limited understanding is always included by the terms “obtained” or “defined” as a preferred embodiment.

Whenever the terms “including” or “having” are used, these terms are meant to be equivalent to “comprising” as defined hereinabove.

According to the present invention, use of particulate mineral material comprising modified heulandite group zeolite for removing heavy metal cations from a liquid medium is provided, wherein at least a part of the exchangeable cations in the heulandite group zeolite is replaced by ammonium cations.

In the following details and preferred embodiments of the inventive use will be set out in more details. It is to be understood that these technical details and embodiments also apply to the inventive method and system.

The Particulate Mineral Material

According to the present invention, a particulate mineral material comprising modified heulandite group zeolite is used for removing heavy metal cations from an aqueous medium.

Zeolites are crystalline aluminosilicates having a porous physical structure with interconnected cavities in which metal cations and water molecules are contained. The zeolites have reversible hydration properties in addition to their cation exchange properties. The fundamental building block of the zeolites is a tetrahedron of four oxygen atoms surrounding a relatively small silicon or aluminum atom. The structure consists of SiO4 and A104 tetrahedra arranged so that each oxygen atom is shared between two tetrahedral (cf. Barros et al., Braz. J. Chem. Eng., 1997, 14(3), 00, https://dx.doi.org/10.1590/S0104-66321997000300006).

For the purpose of the present invention, the term “heulandite group zeolite” refers to a zeolite with the framework type HEU, as defined by the International Zeolite Association. The HEU framework contains three sets of intersecting channels all located in the (010) plane. Two of the channels are parallel to the c-axis: the A channels are formed by strongly compressed ten-membered rings (aperture 3.0×7.6 Å) and B channels are confined by eight-membered rings (aperture 3.3×4.6 Å). C channels are parallel to the a-axis, and they are also formed by eight-membered rings (aperture 2.6×4.7 Å). Zeolites that have the framework type HEU are heulandite and clinoptilolite (cf. Ch. Baerlocher and L. B. McCusker, Database of Zeolite Structures: http://www.iza-structure.org/databases/; and http://europe.iza-structure.org/IZA-SC/framework.php?STC=HEU). Said materials can be clearly identified by their powder diffraction patterns.

Heulandite comprises the mineral species Heulandite-Ca, Heulandite-Na, Heulandite-K, Heulandite-Sr, and Heulandite-Ba. Heulandite-Ca, the most common of these, is a hydrous calcium and aluminium silicate, (Ca,Na)5(Si27Al9)O72.26H2O. Small amounts of sodium and potassium are usually present replacing part of the calcium. Strontium replaces calcium in the heulandite-Sr variety. The appropriate species name depends on the dominant element (see Wikipedia contributors, ‘Heulandite’, Wikipedia, The Free Encyclopedia, 20 Jul. 2017, and https://www.mindat.org/min-6988.html). Clinoptilolite is isostructural to heulandite and has an approximate chemical formula of (Na, K, Ca)6Al6Si30O72.20H2O, and the Si/Al ratio may vary from 4.0 to 5.3 (cf. Ambrozova et. al., Molecules, 2017, 22, 1107).

Heulandite group zeolite can be mined from natural resources or can be produced synthetically. In case the heulandite group zeolite is obtained from natural resources its precise composition, the number of its constituents and the amount of the single constituents may vary in a broad range usually depending on the source of origin, it may comprise additional minerals such as quartz, kaolinite, mica, feldspar, pyrite, calcite, cristoballite, clay, other zeolites, and mixtures thereof, as concomitant minerals in variable amounts.

According to one embodiment of the present invention, the heulandite group zeolite is heulandite and/or clinoptilolite, preferably clinoptilolite.

Clinoptilolite minerals are the most common zeolites in nature and have been found in many areas all around the world, for instance, in Europe (Hungary, Italy, Romania, Slovakia, Slovenia, Turkey, former Yugoslavia), in Russia and several states of the former Soviet Union (Georgia, Ukraine, Azerbaijan), Asia (China, Iran, Japan, Korea), Africa (South Africa), Australia and New Zealand, and in many countries of the Americas, such as Argentina, Cuba, Mexico and the United States. Parent rocks commonly contain over 50% of clinoptilolite, but contents over 80% are very widespread too (cf. Ambrozova et. al., Molecules, 2017, 22, 1107).

Clinoptilolite can be mined from natural resources or can be produced synthetically. Methods for producing clinoptilolite are known in the art and are, for example, described in U.S. Pat. No. 4,623,529 A, or EP 0 681 991 A1. Clinoptilolite is commercially available, for example, from Gordes Zeolite (Turkey), Zeocem AG (Slovenia), KMI Zeolite Inc. (USA), Rota Mining Corporation (USA), or Bear River Zeolite Co. (USA).

It is known to the skilled person that in case the clinoptilolite is obtained from natural resources its precise composition, the number of its constituents and the amount of the single constituents may vary in a broad range usually depending on the source of origin. For example, the clinoptilolite obtained from clinoptilolite-containing tuffs may contain at least 80 wt.-% clinoptilolite as the main component, but also quartz, kaolinite, mica, feldspar, pyrite, calcite, cristoballite, clay, other zeolites, and mixtures thereof, as concomitant minerals. These minerals may be present in variable amounts, as well as other components, depending on the site of origin.

The heulandite group zeolite source material may be pre-treated, e.g., in order to increase its porosity or ion exchange capacity. For example, the heulandite group zeolite may be subjected to one or several of the following treatments:
i. treatments with acids with an acid dissociation constant pKₐ=2 or lower, such as sulfuric acid, nitric acid, or hydrochloric acid, e.g. with the purpose of ion-exchanging the zeolite, dealuminating the zeolite, increasing the phase purity of the zeolite, and/or generating additional micro- and/or mesopores,
ii. treatments with bases selected from hydroxide salts such as alkali metal hydroxides, e.g. with the purpose of ion-exchanging the zeolite, desilicating the zeolite, increasing the phase purity of the zeolite, and/or generating additional micro- and/or mesopores,
iii. treatments with alkali metal salts such as sodium salts and/or potassium salts, e.g. with the purpose of ion-exchanging the zeolite, and
iv. high-temperature and/or pressure treatments with steam (“steaming”), e.g. with the purpose of dealuminating the zeolite framework, and/or increasing the thermal stability of the zeolite.

According to one embodiment of the present invention, a particulate heulandite group zeolite source material may have a heulandite group zeolite content of at least 50 wt.-%, preferably at least 75 wt.-%, more preferably at least 90 wt.-%, even more preferably at least 95 wt.-%, and most preferably at least 98 wt.-%, based on the total weight of the particulate heulandite group zeolite source material. According to another embodiment the particulate heulandite group zeolite source material consists of heulandite group zeolite. According to one embodiment of the present invention, the heulandite group zeolite is clinoptilolite and the particulate clinoptilolite source material may have a clinoptilolite content of at least 50 wt.-%, preferably at least 75 wt.-%, more preferably at least 90 wt.-%, even more preferably at least 95 wt.-%, and most preferably at least 98 wt.-%, based on the total weight of the particulate clinoptilolite source material. According to another embodiment the particulate clinoptilolite source material consists of clinoptilolite.

According to one embodiment the particulate heulandite group zeolite source material has a weight median particle size d50 from 0.05 to 500 μm, preferably from 0.2 to 200 μm, more preferably from 0.4 to 100 μm, and most preferably from 0.6 to 20 μm, and/or a weight top cut particle size d98 from 0.15 to 1500 μm, preferably from 1 to 600 μm, more preferably from 1.5 to 300 μm, and most preferably from 2 to 80 μm. According to one embodiment the heulandite group zeolite is clinoptilolite and the particulate clinoptilolite source material has a weight median particle size d50 from 0.05 to 500 μm, preferably from 0.2 to 200 μm, more preferably from 0.4 to 100 μm, and most preferably from 0.6 to 20 μm, and/or a weight top cut particle size d98 from 0.15 to 1500 μm, preferably from 1 to 600 μm, more preferably from 1.5 to 300 μm, and most preferably from 2 to 80 μm.

A “modified heulandite group zeolite” in the meaning of the present invention refers to a heulandite group zeolite, wherein at least a part of the exchangeable cations in the heulandite group zeolite is replaced by ammonium cations. For the purpose of the present invention, the term “exchangeable cations” refers to positively charged ions which are loosely attached to the zeolite framework and can be exchanged by a cation of an added solute solution. The total number of these positively charged ions is known as the Cation Exchange Capacity (CEC). Exchangeable cations contained in heulandite group zeolite are typically cations of alkali metals and alkaline earth metals such as lithium, sodium, potassium, magnesium, calcium, or hydrogen, preferably sodium and potassium cations.

According to a preferred embodiment, a particulate mineral material comprising modified clinoptilolite is used for removing heavy metal cations from an aqueous medium. A “modified clinoptilolite” in the meaning of the present invention refers to a clinoptilolite, wherein at least a part of the exchangeable cations in the clinoptilolite is replaced by ammonium cations. Exchangeable cations contained in clinoptilolite are typically cations of alkali metals and alkaline earth metals such as lithium, sodium, potassium, magnesium, calcium, or hydrogen, preferably sodium and potassium cations.

According to one embodiment of the present invention at least 70% of the exchangeable cations in the heulandite group zeolite are replaced by ammonium cations, preferably at least 90% of the exchangeable cations in the clinoptilolite are replaced by ammonium cations, more preferably at least 95% of the exchangeable cations in the heulandite group zeolite are replaced by ammonium cations, and most preferably all exchangeable cations in the heulandite group zeolite are replaced by ammonium cations. According to another embodiment, the cation exchange capacity of the heulandite group zeolite is from 0.2 to 2.9 mmol NH4+/g zeolite, preferably from 0.5 to 2.5 mmol NH4+/g zeolite, and most preferably from 1.0 to 2.0 mmol NH4+/g zeolite. The amount of ion-exchanged ammonium cations may be determined by any method known to the skilled person. According to one embodiment, the percentage of ammonium cations within the modified heulandite group zeolite is determined by measuring the cation exchange capacity of the heulandite group zeolite (e.g. as described in Ming and Dixon, Clays and Clay Minerals 1987, 35(6), 463-468), determining the quantity of ammonium in the heulandite group zeolite by elemental analysis of nitrogen, and comparing the quantity of ammonium in the zeolite (determined by elemental analysis of nitrogen) to the cation exchange capacity.

As mentioned above, heulandite group zeolite obtained from natural resources may comprise not only heulandite group zeolite but also other constituents. Accordingly the particular mineral material comprising modified heulandite group zeolite may also comprise additional constituents. According to one embodiment the particulate mineral material has a content of modified heulandite group zeolite of at least 50 wt.-%, preferably at least 75 wt.-%, more preferably at least 90 wt.-%, even more preferably at least 95 wt.-%, and most preferably at least 98 wt.-%, based on the total weight of the particulate mineral material. According to another embodiment the particulate mineral material consists of modified heulandite group zeolite. According to one embodiment the particular mineral material comprises modified clinoptilolite and has a content of modified clinoptilolite of at least 50 wt.-%, preferably at least 75 wt.-%, more preferably at least 90 wt.-%, even more preferably at least 95 wt.-%, and most preferably at least 98 wt.-%, based on the total weight of the particulate mineral material. According to another embodiment the particulate mineral material consists of modified clinoptilolite.

According to one embodiment the particulate mineral material has a weight median particle size d50 from 0.05 to 500 μm, preferably from 0.2 to 200 μm, more preferably from 0.4 to 100 μm, and most preferably from 0.6 to 20 μm, and/or a weight top cut particle size d98 from 0.15 to 1500 μm, preferably from 1 to 600 μm, more preferably from 1.5 to 300 μm, and most preferably from 2 to 80 μm. According to a further embodiment, the particulate mineral material has a weight median particle size d50 from 0.05 to 100 μm, preferably from 0.05 to 20 μm, more preferably from 0.2 to 100 μm, even more preferably from 0.2 to 20 μm, and most preferably from 0.4 to 20 μm. In addition or alternatively, the particulate mineral material may have a weight top cut particle size d98 from 0.15 to 300 μm, preferably from 0.15 to 80 μm, more preferably from 1 to 300 μm, even more preferably from 1 to 80 μm, and most preferably from 1.5 to 80 μm.

According to one embodiment the particulate mineral material has a specific surface area of from 5 m2/g to 200 m2/g, preferably from 10 m2/g to 180 m2/g, more preferably from 20 m2/g to 170 m2/g, even more preferably from 25 m2/g to 150 m2/g, and most preferably from 30 m2/g to 120 m2/g, measured using nitrogen sorption and the BET method. According to a further embodiment the particulate mineral material has a specific surface area of from 20 m2/g to 200 m2/g, preferably from 25 m2/g to 200 m2/g, more preferably from 30 m2/g to 200 m2/g, even more preferably from 25 m2/g to 180 m2/g, and most preferably from 25 m2/g to 120 m2/g, measured using nitrogen sorption and the BET method.

According to one embodiment the surface of the particulate mineral material is free of halogen compounds, preferably free of halogen compounds selected from the group consisting of chlorides, chlorates, hypochlorites, bromides, bromates, hypobromites, iodides, iodates, hypoiodites, and mixtures thereof, and most preferably free of halogen compounds selected from the group consisting of bromine, chlorine, iodine, sodium bromide, calcium bromide, magnesium bromide, copper (II) bromide, iron (II) bromide, iron (III) bromide, zinc bromide, potassium bromide, copper (I) chloride, copper (II) chloride, iron (II) chloride, iron (III) chloride, zinc chloride, calcium hypochlorite, calcium hypobromite, calcium hypoiodite, calcium chloride, calcium iodide, magnesium chloride, magnesium iodide, sodium chloride, sodium iodide, potassium tri-chloride, potassium tri-bromide, potassium tri-iodide, or mixtures thereof.

The particulate mineral material comprising modified heulandite group zeolite may be prepared by contacting a particulate heulandite group zeolite source material with an aqueous solution comprising at least one water-soluble ammonium salt. Thereby, at least a part of the exchangeable cations in the heulandite group zeolite is replaced by ammonium cations.

According to one embodiment, the particulate mineral material comprising modified heulandite group zeolite is obtained by contacting a particulate heulandite group zeolite source material with an aqueous solution comprising at least one water-soluble ammonium salt. Thus, a method for preparing a particulate mineral material comprising modified heulandite group zeolite comprises the steps of:

i) providing a particulate heulandite group zeolite source material, wherein the heulandite group zeolite comprises exchangeable cations,

ii) providing at least one water-soluble ammonium salt, and

iii) treating the particulate heulandite group zeolite source material of step i) with the aqueous solution of step ii) in the presence of water to form particulate mineral material comprising modified heulandite group zeolite, wherein at least a part of the exchangeable cations in the heulandite group zeolite is replaced by the ammonium cations of the water-soluble ammonium salt.

The particulate heulandite group zeolite source material may be selected from any suitable source material known to the skilled person.

The particulate heulandite group zeolite source material may be ground to obtain the desired particle size. The grinding may be carried out with any conventional grinding device, for example, under conditions such that refinement predominantly results from impacts with a secondary body, e.g. in one or more of: a ball mill, a rod mill, a vibrating mill, a sand mill, a roll crusher, a centrifugal impact mill, a vertical bead mill, an attrition mill, a pin mill, a hammer mill, a pulveriser, a shredder, a de-clumper, a knife cutter, or other such equipment known to the skilled man.

The particulate heulandite group zeolite source material can be provided in solid form or in form of an aqueous suspension. According to one embodiment the particulate heulandite group zeolite source material is provided in form of an aqueous suspension, preferably comprising the particulate heulandite group zeolite source material in an amount from 0.1 to 99 wt.-%, based on the total weight of the aqueous suspension, preferably in an amount from 1 to 80 wt.-%, more preferably in an amount from 10 to 60 wt.-%, and most preferably in an amount from 30 to 50 wt.-%.

The water-soluble ammonium salt can be provided in solid form or in form of an aqueous solution.

According to one embodiment, the water-soluble ammonium salt is provided in form of an aqueous solution, preferably comprising the water-soluble ammonium salt in an amount from 0.1 to 99 wt.-%, based on the total weight of the aqueous solution, more preferably in an amount from 1 to 80 wt.-%, even more preferably in an amount from 10 to 50 wt.-%, and most preferably in an amount from 20 to 40 wt.-%. According to one embodiment the aqueous solution comprising the at least one water-soluble ammonium salt has an ammonium cation concentration from 0.001 to 20 mol/1, preferably from 0.01 to 15 mol/1, more preferably from 1 to 7.5 mol/1, and most preferably from 2 to 5 mol/1.

The at least one water-soluble ammonium salt may be selected from any suitable water-soluble ammonium salt known to the skilled person, preferably the water-soluble ammonium salt is an inorganic water-soluble ammonium salt. According to one embodiment the at least one water-soluble ammonium salt is selected from ammonium nitrate, ammonium chloride, ammonium bromide, ammonium iodide, ammonium perchlorate, ammonium hydroxide, ammonium carbonate, ammonium sulfate, ammonium phosphate, or mixtures thereof, preferably the at least one water-soluble ammonium salt is ammonium nitrate or ammonium hydroxide.

According to one embodiment the at least one water-soluble ammonium salt is provided in an amount so that the amount of ammonium cations in the water-soluble ammonium salt is from 0.05 to 20 wt.-%, based on the total weight of the particulate mineral material, preferably in an amount from 0.25 to 7.5 wt.-%, more preferably in an amount from 0.5 to 4 wt.-%, and most preferably in an amount from 1 to 3 wt.-%.

The treatment step iii) may be carried by any means known to the skilled person. For example, in treatment step iii) the particulate clinoptilolite source material of step i) may be mixed with the aqueous solution of step ii). Suitable mixing methods are known to the skilled person. Examples of suitable mixing methods are shaking, mixing, stirring, agitating, ultrasonication, or inducing a turbulent or laminar flow by means such as baffles or lamellae. Suitable mixing equipment is known to the skilled person, and may be selected, for example, from stirrers, such as rotor stator systems, blade stirrers, propeller stirrers, turbine stirrers, or anchor stirrers, static mixers such as pipes including baffles or lamellae. According to an exemplary embodiment of the present invention, a rotor stator stirrer system is used. The skilled person will adapt the mixing conditions such as the mixing speed and temperature according to his process equipment.

According to one embodiment step iii) is carried out two or more times, preferably two times.

According to one embodiment the particulate mineral material comprising modified heulandite group zeolite obtained in step iii) is separated from the water and dried. Thus, the method for preparing a particulate mineral material comprising modified heulandite group zeolite comprises the steps of:

i) providing a particulate heulandite group zeolite source material, wherein the heulandite group zeolite comprises exchangeable cations,

i) providing at least one water-soluble ammonium salt, and

iii) treating the particulate heulandite group zeolite source material of step i) with the aqueous solution of step ii) in the presence of water to form particulate mineral material comprising modified heulandite group zeolite, wherein at least a part of the exchangeable cations in the heulandite group zeolite is replaced by the ammonium cations of the water-soluble ammonium salt,

iv) separating the particulate mineral material obtained in step iii) from the water, and/or

v) drying the particulate mineral material.

The particulate mineral material comprising modified heulandite group zeolite may be separated from the water by any conventional means of separation known to the skilled person. For example, the particulate mineral material may be separated mechanically and/or thermally. Examples of mechanical separation processes are filtration, e.g. by means of a drum filter or filter press, nanofiltration, or centrifugation. An example for a thermal separation process is a concentrating process by the application of heat, for example, in an evaporator. According to a preferred embodiment, in process step iv) the particulate mineral material is separated mechanically, preferably by filtration, sedimentation and/or centrifugation.

After separation or alternatively, the particulate mineral material can be dried in order to obtain dried particulate mineral material. According to one embodiment, the process further comprises a step v) of drying the particulate mineral material after step iii) or after step iv), if present, at a temperature in the range from 60 to 500° C., preferably until the moisture content of the particulate mineral material is less than or equal to 10 wt.-%, based on the total weight of the dried particulate mineral material. In general, the drying may take place using any suitable drying equipment and can, for example, include thermal drying and/or drying at reduced pressure using equipment such as an evaporator, a flash drier, an oven, a spray drier and/or drying in a vacuum chamber. The drying step can be carried out at reduced pressure, ambient pressure or under increased pressure. For temperatures below 100° C. it may be preferred to carry out the drying step under reduced pressure.

Heavy Metal Removal

According to one aspect of the present invention use of particulate mineral material comprising modified heulandite group zeolite particles for removing heavy metal cations from a liquid medium is provided, wherein at least a part of the exchangeable cations in the heulandite group zeolite is replaced by ammonium cations.

The liquid medium containing the heavy metal cations may be an organic medium or an aqueous medium.

According to one embodiment the liquid medium is an organic medium. The term “organic” medium refers to a liquid system, wherein the liquid phase consists of an organic solvent. For example, the organic medium may be an alcohol, an amide, an amine, an aromatic solvent, a ketone, an aldehyde, an ether, an ester, a carboxylic acid, a sulfoxide, an halogenated organic solvents, a nitro solvent, or a mixture thereof. According to one embodiment the organic medium is selected from methanol, ethanol, propanol, isopropanol, butanol, ethylene glycol, diethylene glycol, glycerol, dimethyl acetamide, dimethyl formamide, 2-pyrrolidone, piperidine, pyrrolidine, quinoline, benzene, benzyl alcohol, chlorobenzene, 1,2-dichlorobenzene, mesitylene, nitrobenzene, pyridine, tetralin, toluene, xylene, diisopropylether, diethylether, dibutylether, 1,4-dioxane, tetrahydrofuran, tetrahydropyran, morpholine, acetone, acetophenone, cyclopentanone, ethyl isopropyl ketone, 2-hexanone, pentanone, isopropyl acetate, formic acid, dimethyl sulfoxide, benzotrichloride, bromoform, carbon tetrachloride, chloroform, chloromethane, linear alkanes, branched alkanes, petroleum distillate fractions, crude oil, and mixtures thereof.

According to another embodiment of the present invention, the liquid medium is an aqueous medium. The term “aqueous” medium refers to a liquid system, wherein the liquid phase comprises, preferably consists of, water. However, said term does not exclude that the liquid phase of the aqueous medium comprises minor amounts of at least one water-miscible organic solvent. Examples of water-miscible organic solvents are methanol, ethanol, acetone, acetonitrile, tetrahydrofuran and mixtures thereof. If the aqueous medium comprises at least one water-miscible organic solvent, the liquid phase of the aqueous medium comprises the at least one water-miscible organic solvent in an amount of from 0.1 to 40.0 wt.-% preferably from 0.1 to 30.0 wt.-%, more preferably from 0.1 to 20.0 wt.-% and most preferably from 0.1 to 10.0 wt.-%, based on the total weight of the liquid phase of the aqueous medium. According to one embodiment, the liquid phase of the aqueous medium consists of water.

The aqueous medium may be process water, sewage water, waste water, sludge, or an effluent of dewatered sludge. According to one embodiment the aqueous medium is selected from process water, sewage water, waste water, preferably waste water from the paper industry, waste water from the colour-, paints-, or coatings industry, waste water from breweries, waste water from the leather industry, agricultural waste water, slaughterhouse waste water, process or waste water from power plants, waste water from waste incineration, waste water from mercury recycling, waste water from cement production, waste water from steel production, waste water from production of fossil fuels, from sludge, preferably sewage sludge, harbour sludge, river sludge, coastal sludge, digested sludge, mining sludge, municipal sludge, civil engineering sludge, sludge from oil drilling or the effluents the aforementioned dewatered sludges. According to one embodiment, the waste water from power plants is process or waste water from coal-fired power plants, preferably coal-fired power plants based on lignite.

Within the context of the present invention, the term “process water” refers to any water which is necessary to run or maintain an industrial process. The term “sewage water” refers to wastewater that is produced by a community of people, i.e. domestic wastewater or municipal wastewater. The term “waste water” refers to any water drained from its place of use, e.g. an industrial plant. The term “sludge” in the meaning of the present invention refers to any kind of sludge, e.g. primary sludge, biological sludge, mixed sludge, digested sludge, physico-chemical sludge and mineral sludge. In this regard, primary sludge comes from the settling process and usually comprises large and/or dense particles. Biological sludge comes from the biological treatment of wastewater and is usually made of a mixture of microorganisms. These microorganisms, mainly bacteria, amalgamate in bacterial flocs through the synthesis of exo-polymers. Mixed sludge is a blend of primary and biological sludges and usually comprises 35 wt.-% to 45 wt.-% of primary sludge and 65 wt.-% to 55 wt.-% of biological sludge. Digested sludge comes from a biological stabilizing step in the process called digestion and is usually performed on biological or mixed sludge. It can be done under different temperatures (mesophilic or thermophilic) and with or without the presence of oxygen (aerobic or anaerobic). Physico-chemical sludge is the result of a physico-chemical treatment of the wastewater and is composed of flocs produced by the chemical treatment. Mineral sludge is given to sludge produced during mineral processes such as quarries or mining beneficiation processes and essentially comprises mineral particles of various sizes.

For the purpose of the present invention, the term “heavy metal” refers a metal having a density of more than 5 g/cm3. According to one embodiment the heavy metal cations are selected from the group consisting of arsenic, cadmium, chromium, cobalt, copper, gold, iron, lead, manganese, mercury, molybdenum, nickel, silver, tin, zinc, or mixtures thereof, preferably the heavy metal cations are selected from the group consisting of cadmium, copper, lead, mercury, zinc, or mixtures thereof, more preferably the heavy metal cations are selected from the group consisting of copper, lead, mercury, or mixtures thereof, and most preferably the heavy metal cations are mercury cations.

According to a further aspect of the present invention, a method for removing heavy metal cations from a liquid medium is provided, wherein the method comprises the steps of:

a) providing a liquid medium containing heavy metal cations,

b) providing particulate mineral material comprising modified heulandite group zeolite, wherein at least a part of the exchangeable cations in the heulandite group zeolite is replaced by ammonium cations, and

c) contacting the particulate mineral material of step b) with the liquid medium of step a) to remove heavy metal cations from the liquid medium by forming a heavy metal loaded particulate mineral material.

The particulate mineral material of step b) may be prepared in a separate process. Thus, the particulate mineral material may be prepared by a method comprising the steps of:

i) providing a particulate heulandite group zeolite source material, wherein the heulandite group zeolite comprises exchangeable cations,

ii) providing an aqueous solution comprising at least one water-soluble ammonium salt, and

iii) treating the particulate heulandite group zeolite source material of step i) with the aqueous solution of step ii) to form particulate mineral material comprising modified heulandite group zeolite, wherein at least a part of the exchangeable cations in the heulandite group zeolite is replaced by the ammonium cations of the water-soluble ammonium salt.

Alternatively, the particulate mineral material of step b) may be prepared in-situ. Accordingly, method step b) of the method of the present invention would be replaced by method steps i) to iii) described above. Thus, the method for removing heavy metal cations from a liquid medium may comprise the steps of:

A) providing a liquid medium containing heavy metal cations,

B) providing a particulate heulandite group zeolite source material, wherein the heulandite group zeolite comprises exchangeable cations,

C) providing an aqueous solution comprising at least one water-soluble ammonium salt,

D) treating the particulate heulandite group zeolite source material of step B) with the aqueous solution of step C) to form particulate mineral material comprising modified heulandite group zeolite, wherein at least a part of the exchangeable cations in the heulandite group zeolite is replaced by the ammonium cations of the water-soluble ammonium salt, and

E) contacting the particulate mineral material comprising modified heulandite group zeolite obtained in step D) with the liquid medium of step A) to remove heavy metal cations from the liquid medium by forming a heavy metal loaded particulate mineral material.

Materials and methods for preparing the particulate mineral material modified heulandite group zeolite are described above.

Unless indicated otherwise, the following explanations and embodiments apply to both methods, i.e. to the method wherein the particulate mineral material is prepared separately and to the method wherein the particulate mineral material is prepared in-situ. Accordingly, all explanations and embodiments described for method step c) also apply to method step E).

In general, the liquid medium and the particulate mineral material comprising modified heulandite group zeolite can be brought into contact by any conventional means known to the skilled person.

For example, the contacting step c) may takes place in that the surface of the liquid medium is at least partially covered with the particulate mineral material. Additionally or alternatively, the step of contacting may takes place in that the liquid medium is mixed with the particulate mineral material. The skilled man will adapt the mixing conditions (such as the configuration of mixing speed) according to his needs and available equipment. According to a preferred embodiment the particulate mineral material is suspended in the liquid medium to be treated, e.g. by agitation means.

The contacting step c) may be carried out for a time period in the range of several seconds to several minutes, e.g. 20 s or more, preferably 30 s or more, more preferably 60 s or more, and most preferably for a period of 120 s or more. According to one embodiment step c) is carried out for at least 3 min, at least 4 min, at least 5 min, at least 10 min, at least 20 min, or at least 30 min.

The contacting may be carried out under stirring or mixing conditions. Any suitable mixer or stirrer known to the skilled person may be used. The mixing or stirring may be performed at a rotational speed of 10 rpm to 20000 rpm. In a preferred embodiment the mixing or stirring is performed at a rotational speed of 10 rpm to 1500 rpm, for example, at a rotational speed of 100 rpm, or 200 rpm, or 300 rpm, or 400 rpm, or 500 rpm, or 600 rpm, or 700 rpm, or 800 rpm, or 900 rpm, or 1000 rpm.

According to one embodiment the contacting step c) is carried out for a period in the range of 60 s to 180 s under mixing conditions at a rotational speed of 100 rpm to 1000 rpm. For example, the contacting is carried out for 120 s at a rotational speed of 300 rpm.

In general, the length and the rotational speed of contacting the liquid medium to be treated with the particulate mineral material is determined by the degree of liquid medium pollution and the specific liquid medium to be treated.

The contacting step c) can be carried out by providing the particulate mineral material comprising modified clinoptilolite in a suitable amount. A suitable amount in this context is an amount, which is sufficiently high in order to achieve the desired grade of removal of heavy metal cations. It will be appreciated that such suitable amount will depend on the concentration of the heavy metal cations in the liquid medium as well as the amount of liquid medium to be treated.

According to one embodiment of the present invention the particulate mineral material comprising modified heulandite group zeolite is provided in an amount from 0.01 to 3 wt.-%, based on the total weight of the liquid medium, preferably in an amount from 0.05 to 2 wt.-%, and more preferably in an amount from 0.1 to 1 wt.-%.

According to one embodiment the particulate mineral material comprising modified heulandite group zeolite is provided in a weight ratio of from 1:20000 to 1:30, preferably from 1:10000 to 1:35, more preferably from 1:1000 to 1:40 and most preferably from 1:850 to 1:45, relative to the weight of the heavy metal cations in the liquid medium.

The particulate mineral material comprising modified heulandite group zeolite can be provided as an aqueous suspension. Alternatively, it can be added to the liquid medium in any suitable solid form, e.g. in the form of a powder, granules, agglomerates, pellets or in form of a paste, moist particles, moist pieces, or moist cake.

Within the context of the present invention, it is also possible to provide an immobile phase, e.g. in the form of a cake or layer, comprising the particulate mineral material comprising modified heulandite group zeolite, wherein the liquid medium to be treated runs through said immobile phase. According to another embodiment, the contacting step c) is carried out by passing the liquid medium through a bed and/or column of the particulate mineral material. For example, contacting step c) is carried out by passing the liquid medium through a fixed bed installation, a packed column, a fluid bed contactor, or combinations thereof. Advantageously, for such installations the particulate mineral material comprising modified heulandite group zeolite is processed into a technical body (such as a pellet, tablet, granule, or extrudate).

According to another embodiment, the liquid medium is passed through a permeable filter comprising the particulate mineral material comprising modified heulandite group zeolite and being capable of retaining, via size exclusion, the particulate mineral material including the scavenged heavy metal cations, on the filter surface as the liquid is passed through by gravity and/or under vacuum and/or under pressure. This process is called “surface filtration”. In another preferred technique known as depth filtration, a filtering aid comprising a number of tortuous passages of varying diameter and configuration retains heavy metal cations by molecular and/or electrical forces absorbing the particulate mineral material including the scavenged heavy metal cations which is present within said passages, and/or by size exclusion, retaining the heavy metal cations scavenged by the particulate mineral material if it is too large to pass through the entire filter layer thickness. The techniques of depth filtration and surface filtration may additionally be combined by locating the depth filtration layer on the surface filter; this configuration presents the advantage that those particles that might otherwise block the surface filter pores are retained in the depth filtration layer.

The method of the present invention can be carried out in form of a batch process, a semi-continuous process, or a continuous process. Preferably, the method is carried out as a continuous process. According to one embodiment the particulate mineral material is dosed continuously into the liquid medium, wherein the particulate mineral material is in form of an aqueous suspension or in solid form, preferably in form of powder, granules, agglomerates, pellets or mixtures thereof. Alternatively, the liquid medium is passed continuously through an immobile phase, preferably a fixed bed installation, a packed column, a fluid bed contactor, or combinations thereof.

The inventors of the present invention surprisingly found that a particulate mineral material comprising modified heulandite group zeolite can be effectively used to absorb a broad range of heavy metal cations from liquid media. In particular, it was found that the particulate mineral is highly effective in mercury removal.

It is an advantage of the present invention that the particulate mineral material comprising modified heulandite group zeolite is derivable from natural resources and can be produced in a fast, uncomplicated and cost-effective manner. Furthermore, the particular material can be easily removed from the liquid medium to be treated and is environmentally benign. Thus, it is possible to remove heavy metal cations from liquid media with no or very limited technical equipment.

### FURTHER EMBODIMENTS

Unless indicated otherwise, the following explanations and embodiments also apply to method wherein the particulate mineral material is produced in-situ comprising steps A) to E) defined above. The skilled person will understand that in said case, process step d) corresponds to process step F), and process step f) corresponds to process step G).

According to one embodiment, during and/or after step c) at least one flocculation aid selected from polymeric and/or non-polymeric flocculation aids is added. For example, the flocculation aid and the particulate mineral material are added simultaneously to the liquid medium containing heavy metal cations. Alternatively, the flocculation aid and the particulate mineral material are added separately to liquid medium. In this case, the liquid medium may be first contacted with the particulate mineral material and then with the flocculation aid. The skilled person will adapt the treatment conditions and flocculation aid concentration according to his needs and available equipment.

According to one embodiment the flocculation aid is a polymeric flocculation aid. The polymeric flocculation aid can be non-ionic or ionic and preferably is a cationic or anionic polymeric flocculation aid. Any polymeric flocculation aid known in the art can be used in the process of the present invention. Examples of polymeric flocculation aids are disclosed in WO 2013/064492 A1. Alternatively, the polymeric flocculation aid may be a polymer as described as comb polymer in US 2009/0270543 A1. In a preferred embodiment the polymeric flocculation aid is a cationic or anionic polymer selected from polyacrylamides, polyacrylates, poly(diallyldimethylammonium chloride), polyethyleneimines, polyamines or mixtures of these, and natural polymers such as starch, or natural modified polymers like modified carbohydrates. Preferably, the polymeric flocculation aid may have a weight average molecular weight of at least 100000 g/mol. In a preferred embodiment, the polymeric flocculation aid has a weight average molecular weight Mw in the range from 100000 to 10000000 g/mol, preferably in the range from 300000 to 5000000 g/mol, more preferably in the range from 300000 to 1000000 g/mol, and most preferably in the range from 300000 to 800000 g/mol.

According to another embodiment the flocculation aid is a non-polymeric flocculation aid. The non-polymeric flocculation aid may be a cationic flocculating agent comprising a salt of a fatty acid aminoalkyl alkanolamide of the following general structure:

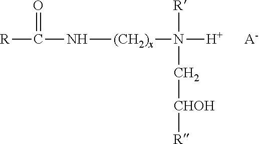

wherein R is a carbon chain of a fatty acid having from 14 to 22 carbon atoms, R′ is H, or C1 to C6 alkyl group, R″ is H, or CH₃, x is an integer of 1-6, and A is an anion. Examples of such non-polymeric flocculation aids are disclosed in U.S. Pat. No. 4,631,132 A.

According to a preferred embodiment of the present invention the flocculation aid is a non-polymeric flocculation aid selected from inorganic flocculation aids, for example selected from aluminium sulphate (Al2(504)3), or powder activated carbon (PAC). Such flocculation aids are known by the skilled person and are commercially available.

Optionally, further additives can be added to the liquid medium. These might include, for example, agents for pH adjustment or phyllosilicates. The at least one phyllosilicate is preferably bentonite. Accordingly, the at least one phyllosilicate preferably comprises bentonite, more preferably consists of bentonite.

According to one embodiment the method further comprises a step d) of removing the heavy metal loaded particulate mineral material from the liquid medium after step c), preferably step d) is performed by filtration, centrifugation, sedimentation, or flotation.

The heavy metal loaded particulate mineral material may be separated from the liquid medium by any conventional means of separation known to the skilled person. According to one embodiment of the present invention, in process step d) the modified heulandite group zeolite particles are separated mechanically. Examples of mechanical separation processes are filtration, e.g. by means of a drum filter or filter press, nanofiltration, or centrifugation.

According to one embodiment the method further comprises a step e) of recycling the heavy metal loaded particulate mineral material, wherein the heavy metal loaded particulate mineral material is preferably recycled by a method comprising the step of treating the heavy metal loaded particulate mineral material with ammonium cations and/or gaseous ammonia at room temperature, i.e. at 20° C.±2° C. Optionally, before said step, a thermal treatment may be carried out to remove mercury in gaseous form, preferably the thermal treatment is carried out by heating the heavy metal loaded particulate mineral material to a temperature from 100 to 500° C. in a gas stream.

According to a further aspect of the present invention, a system for removing heavy metal cations from a liquid medium comprising a reactor is provided, wherein the reactor comprises

an inlet for a liquid medium containing heavy metal cations,

particulate mineral material comprising modified heulandite group zeolite, wherein at least a part of the exchangeable cations in the heulandite group zeolite is replaced by ammonium cations, and an outlet for heavy metal cation depleted liquid medium.

According to one embodiment the reactor contains the particulate mineral material in form of pellets and/or the particulate mineral material is provided in form of a bed or column.

According to one embodiment of the present invention, use of particulate mineral material comprising modified heulandite group zeolite for removing heavy metal cations from a liquid medium is provided, wherein at least a part of the exchangeable cations in the heulandite group zeolite is replaced by ammonium cations, and

wherein the use is performed in a system for removing heavy metal cations from a liquid medium comprising a reactor, wherein the reactor comprises

an inlet for the liquid medium containing heavy metal cations,

the particulate mineral material comprising modified heulandite group zeolite, and

an outlet for heavy metal cation depleted liquid medium.

According to a further embodiment a method for removing heavy metal cations from a liquid medium is provided, the method comprising the steps of:

a) providing a liquid medium containing heavy metal cations,

b) providing particulate mineral material comprising modified heulandite group zeolite, wherein at least a part of the exchangeable cations in the heulandite group zeolite is replaced by ammonium cations,

c) contacting the particulate mineral material of step b) with the liquid medium of step a) to remove heavy metal cations from the liquid medium by forming a heavy metal loaded particulate mineral material, and

wherein the method is performed in a system for removing heavy metal cations from a liquid medium comprising a reactor, wherein the reactor comprises

an inlet for the liquid medium containing heavy metal cations,

the particulate mineral material comprising modified heulandite group zeolite, and

an outlet for heavy metal cation depleted liquid medium.

The scope and interest of the invention will be better understood based on the following examples which are intended to illustrate certain embodiments of the present invention and are non-limitative.

### EXAMPLES

### 1. Measuring Methods

In the following, measuring methods implemented in the examples are described. Reference is also made to the methods already described above.

Elemental Analysis

For elemental analysis by X-ray fluorescence (XRF), 0.8 g sample and 6.5 g Li-tetraborate were founded to a glass disk by means of melting decomposition. By means of sequential, wavelength dispersive X-ray fluorescence, the elemental composition of the sample was measured in an ARL™ PERFORM′X Sequential X-Ray Fluorescence Spectrometer by Thermo Scientific. The calculation of the elemental composition was made using a calibration optimized for melting decomposition.

X-Ray Diffraction

For X-ray diffraction, the powered samples were loaded into PMMA sample holders. To attain a reproducible surface for quantitative analysis, a backloading technique was used where the PMMA sample holder was placed on a flat glass plate, loaded from the back, and pressed manually. Samples were analysed with a Bruker D8 Advance powder diffractometer obeying Bragg's law. This diffractometer consists of a 1 kW X-ray tube, a sample holder, a 0-0 goniometer, and a LYNXEYE XE-T detector. The profiles were chart recorded automatically using a scan speed of 0.02° per second in 20. The resulting powder diffraction pattern can easily be classified by mineral content using the DIFFRACsuite software packages EVA and SEARCH, based on reference patterns of the ICDD PDF. Quantitative analysis of diffraction data refers to the determination of amounts of different phases in a multi-phase sample and has been performed using the DIFFRACsuite software package TOPAS.

Nitrogen Sorption

Nitrogen sorption at −196° C. was carried out in a Micromeritics TriStar II instrument by acquiring an 83 point isotherm following a full adsorption-desorption cycle. Prior to the measurement, the samples were evacuated at 300° C. for 3 h. The BET surface (SBET) was determined by applying the Brunauer-Emmett-Teller (BET) equation to the sorption data in the range 0.05<p/p⁰<0.25. The mesopore surface (Sₘₑₛₒ) was calculated by application of the t-plot method in a thickness range of 4.5-6 Å. Single point pore volumes (Vₚₒᵣₑ) were calculated based on the total adsorption at at p/p⁰=0.98.

### 2. Manufacture of the Particulate Mineral Materials

For ion-exchange, natural clinoptilolite obtained from Gordes Zeolite, Turkey (175 g) was introduced into 500 g of a 3.5 wt.-% solution of NaCl, KCl, or NH4NO3, wherein the wt.-% is based on the total weight of the solution, and stirred for 1 h. Subsequently, the slurry was centrifuged at 3000 rpm for 5 min, the supernatant discarded, and the solids re-dispersed in demineralized water for washing. The zeolites were then centrifuged again under identical conditions and the supernatant was discarded.

The as-received clinoptilolite (denoted Clin-P) was subjected to one, two, or three subsequent ion-exchange treatments as described above. The resulting materials were denoted Clin-CX, where C represents the applied salt (Na, K, and NH for NaCl, KCl, and NH4NO3, respectively) and X represents the number of consecutive ion-exchange treatments applied to the sample. As an example, the material Clin-NH2 was subjected to two ion-exchange treatments with NH4NO3.

After the desired number of ion-exchange treatments was conducted, the centrifuged material was dried in an oven at 105° C. and disagglomerated.

Acid treatments were conducted by introducing 175 g of zeolite into 500 g of a HCl solution having a concentration from 0.125 M to 1 M for 1 h, and subsequently applying the same washing and drying protocol as for ion-exchanged zeolites. The resulting materials were denoted Clin-HClY, where Y represents the employed concentration of HCl in M.

### 3. Characterization of the Particulate Mineral Materials

The effect of the treatments on the structure and composition of the zeolites was determined by quantitative XRF analysis and nitrogen sorption analysis (Table 1). The parent material (#A), as well as the ion-exchanged samples (#B-J) evidenced a molar Si/Al ratio of ca. 4.85, a BET surface (SBET) of 52-55 m2 g-1, and a pore volume determined by nitrogen sorption (Vpore) of 0.13 cm3 g-1. As the observed differences lie within the experimental uncertainty of the respective analyses, it can be assumed that no pronounced chemical and/or morphological changes occurred besides the exchange of cations.

In contrast, the samples treated with HCl evidenced an increased surface area, which can result from the dissolution of side-phases, from ion-exchange of the zeolite into protonic form which makes the small micropores accessible to nitrogen, or from the leaching of aluminum from the zeolite which results in the formation of mesopores. The mesopore surface (Smeso) is only increased for the two samples treated at higher concentrations (#K, L), suggesting that the proton ion-exchange of the zeolite is the major source of the increased surface area.

The mineralogical composition of selected samples was quantified by XRD diffraction and is provided in Table 2.

TABLE 1
Physico-chemical properties of the zeolite samples.

| | | Si/Al | | | | | Δ^{b} | S_{BET}^{c}/ | Sₘₑₛₒ^{d} | Vₚₒᵣₑ^{e}/ |
|---|---|---|---|---|---|---|---|---|---|---|
| Sample | zeolite | [mol/mol] | Na^{a} [%] | K^{a} [%] | Ca^{a} [%] | Mg^{a} [%] | [%] | [m²/g] | [m²/g] | [cm³/g] |
| A | Clin-P | 4.84 | 6 | 26 | 44 | 6 | 18 | 52.15 | 41.98 | 0.13 |
| B | Clin-Na1 | 4.84 | 51 | 22 | 24 | 3 | 0 | 52.54 | 43.36 | 0.13 |
| C | Clin-Na2 | 4.84 | 73 | 20 | 12 | 2 | −7 | 50.64 | 39.63 | 0.13 |
| D | Clin-Na3 | 4.86 | 78 | 17 | 12 | 2 | −9 | 53.47 | 43.42 | 0.13 |
| E | Clin-K1 | 4.84 | 1 | 76 | 16 | 2 | 5 | 52.23 | 42.91 | 0.12 |
| F | Clin-K2 | 4.84 | 0 | 90 | 6 | 0 | 4 | 51.94 | 40.63 | 0.13 |
| G | Clin-K3 | 4.84 | 1 | 89 | 6 | 1 | 3 | 54.89 | 44.28 | 0.14 |
| H | Clin-NH1 | 4.84 | 2 | 16 | 16 | 3 | 63 | 53.47 | 43.42 | 0.14 |
| I | Clin-NH2 | 4.85 | 1 | 7 | 2 | 1 | 89 | 55.81 | 45.09 | 0.13 |
| J | Clin-NH3 | 4.85 | 2 | 0 | 0 | 1 | 97 | 54.33 | 43.00 | 0.14 |
| K | Clin-C1 | 5.25 | 4 | 22 | 15 | 2 | 57^{f} | 73.20 | 47.06 | 0.14 |
| L | Clin-C0.5 | 5.13 | 5 | 26 | 19 | 4 | 46^{f} | 66.74 | 46.79 | 0.14 |
| M | Clin-C0.25 | 5.00 | 6 | 27 | 23 | 4 | 40^{f} | 56.13 | 43.08 | 0.14 |
| N | Clin-C0.13 | 4.88 | 6 | 28 | 29 | 6 | 31^{f} | 61.30 | 44.59 | 0.13 |

^{a}Fraction of the effective cation exchange capacity (CEC_{eff}) occupied by the indicated atom.
^{b}Fraction of CEc_{eff} not accounted for by Ca, Mg, Na, K. It can be safely assumed that the indicated value predominantly corresponds to NH₄⁺.
^{c}BET equation applied to N₂ sorption data, p/p⁰ = 0.05-0.25.
^{d}t-plot method, fitted to N₂ sorption data in a thickness range of 4.5-6 Å.
^{e}Single point pore volume based on N₂ sorption, p/p⁰ = 0.98 (≈50 nm pore size, BJH model).
^{f}Percentage values assuming unaltered CEC (ignoring the evidenced Al leaching).

TABLE 2
Mineralogical composition of the zeolites based on quantitative Riedveld analysis.

| | | Clinoptilolite | | | | | | | |
|---|---|---|---|---|---|---|---|---|---|
| | | Heulandite^{a} | Stilbite | Σzeolites | var SiO₂^{b} | Feldspar | Clays | Muscovite | Others |
| Sample | zeolite | [%] | [%] | [%] | [%] | [%] | [%] | [%] | [%] |
| A | Clin-P | 51 | 4 | 55 | 22 | 14 | 4 | 3 | 1 |
| D | Clin-Na3 | 51 | 5 | 56 | 24 | 16 | 0 | 3 | 3^{c} |
| G | Clin-K3 | 48 | 3 | 51 | 25 | 15 | 0 | 5 | 3^{d} |
| J | Clin-NH3 | 48 | 4 | 52 | 25 | 15 | 2 | 5 | 2 |
| K | Clin-C1 | 49 | 3 | 52 | 28 | 15 | 0 | 2 | 2 |
| L | Clin-C0.5 | 50 | 3 | 53 | 27 | 15 | 0 | 3 | 2 |
| M | Clin-C0.25 | 52 | 3 | 55 | 26 | 15 | 0 | 3 | 2 |
| N | Clin-C0.13 | 53 | 3 | 56 | 25 | 14 | 0 | 3 | 2 |

^{a}Clinoptilolite and heulandite are isostructural and with different Si/A1 ratios. This makes discrimination based on XRD challenging, for which reason they were summarized.
^{b}Cristobalite, Quartz, Tridymite.
^{c}1% Halite (NaCl).
^{d}1% Sylvite (KC1).

### 4. Removal of Heavy Metal or Ammonium Cations

Adsorption experiments with heavy metal cations were conducted using stock solutions having a heavy metal cation concentration of 10 ppm (Cd, Cu, Pb and Zn) or 1 ppm (Hg) prepared by dilution of commercial ICP-standards (Cd: 10000 mg L-1 Cd in 5% HNO3, Sigma-Aldrich product 90006-100ML; Cu: 10000 mg L-1 Cu in 2-3% HNO3, Merck product 1.70378.0100; Pb: 1000 mg L-1 Pb in 2% HNO3 Sigma-Aldrich product 41318 100ML-F; Zn: 10000 mg L-1 Zn in 5% HNO3, Merck product 1.70389.0100; Hg: 10000 mg L-1 Hg in 12% HNO3, Sigma-Aldrich product 75111-100ML) with Milli-Q filtered, deionized water. From the stock solutions, the desired quantity was transferred into a glass flask prepared with the desired quantity of mineral, as indicated in the tables. The solids were suspended by magnetic stirring (800 rpm, 1 h) and subsequently filtered through a syringe filter (Chromafil Xtra, RC-20/25 0.2 μm).

The concentration of Cd, Cu, Pb and Zn in the filtered solutions was determined on a Hach Lange DR6000 spectral photometer using Hach Lange LCK 308, LCK 529, LCK 306, and LCK 360 cuvette tests, respectively. Samples were diluted as necessary to match the target range of the cuvette tests. The heavy metals removal performance was calculated by comparison with a blank experiment conducted under identical conditions.

The concentration of Hg was determined in a Perkin Elmer FIMS instrument. For the analysis, 50 μL of the samples was diluted with 50 mL with Milli-Q filtered, deionized water (1:1000), and stabilized with 1 drop of a 5 wt.-% KMnO3 solution and 2 mL of concentrated HNO3. The analysis was conducted within 4 h against a 5-point calibration curve in the range of 0.5-5 ppb.

Comparative adsorption experiments with ammonium cations were conducted using stock solutions having an ammonium cation concentration of 2 ppm, or 20 ppm prepared by dissolution of ammonium nitrate (Sigma-Aldrich) with deionized water. Ca. 100 g of the desired stock solution was transferred into a glass flask prepared with 0.25-0.2 g of one of the minerals indicated in Table 2. The solids were suspended by magnetic stirring (800 rpm, 1 h) and subsequently filtered through a syringe filter (Chromafil Xtra, RC-20/25 0.2 μm).

The ammonium concentrations were determined using a Hach Lange DR6000 spectral photometer using LCK 304 cuvette tests. Samples were diluted as necessary to match the target range of the cuvette tests.

4.1 Cd Removal Experiments

Experiments were conducted to assess the performance of the natural and modified clinoptilolite in the removal of Cd. The results are provided in Table 3.

TABLE 3
Experimental details and results of Cd removal.

| | | | | | | Cd |
|---|---|---|---|---|---|---|
| | | m_{zeolite} | mₛₒₗᵤₜᵢₒₙ | cₛₜₐᵣₜ | c_{end} | removal |
| Example | Zeolite | [g] | [g] | [mg/L] | [%] | [%] |
| 1 | Clin-P | 0.0990 | 96.39 | 7.33 | 5.27 | 28 |
| 2 | Clin-Na1 | 0.1028 | 97.20 | 7.33 | 3.06 | 58 |
| 3 | Clin-Na2 | 0.1021 | 95.29 | 7.33 | 1.62 | 78 |
| 4 | Clin-Na3 | 0.1011 | 94.84 | 7.33 | 1.54 | 79 |
| 5 | Clin-K1 | 0.1000 | 95.56 | 7.33 | 2.82 | 62 |
| 6 | Clin-K2 | 0.1005 | 93.22 | 7.33 | 2.48 | 66 |
| 7 | Clin-K3 | 0.1036 | 96.94 | 7.33 | 4.22 | 42 |
| 8 (inventive) | Clin-NH1 | 0.0992 | 95.53 | 7.33 | 2.64 | 64 |
| 9 (inventive) | Clin-NH2 | 0.0982 | 96.58 | 7.33 | 1.47 | 80 |
| 10 (inventive) | Clin-NH3 | 0.0999 | 95.07 | 7.33 | 0.40 | 95 |
| 11 | Clin-C1 | 0.0987 | 94.59 | 7.33 | 6.36 | 13 |
| 12 | Clin-C0.5 | 0.0990 | 96.19 | 7.33 | 5.82 | 21 |
| 13 | Clin-C0.25 | 0.1041 | 95.67 | 7.33 | 4.71 | 36 |
| 14 | Clin-C0.13 | 0.1013 | 96.57 | 7.33 | 5.85 | 20 |

It can be gathered from the comparison of comparative Example 1 with inventive Examples 8-10 that the modified clinoptilolite zeolite attains a higher Cd removal than the untreated materials. A comparison of the inventive Examples 8-10 with the comparative Examples 2-7 and 11-14 prepared by other treatment protocols evidences a better performance of the inventive particulate mineral materials compared to the comparative particulate mineral materials comprising ion-exchange with other cations or acid treatments.

4.2 Cu Removal Experiments

Experiments were conducted to assess the performance of the natural and modified clinoptilolite in the removal of Cu. The results are provided in Table 4.

TABLE 4
Experimental details and results of Cu removal.

| | | | | | | Cu |
|---|---|---|---|---|---|---|
| | | m_{zeolite} | mₛₒₗᵤₜᵢₒₙ | cₛₜₐᵣₜ | c_{end} | removal |
| Example | Zeolite | [g] | [g] | [mg/L] | [%] | [%] |
| 15 | Clin-P | 0.1031 | 96.51 | 10.1 | 7.01 | 31 |
| 19 | Clin-K1 | 0.0994 | 95.45 | 10.1 | 5.89 | 42 |
| 20 | Clin-K2 | 0.0990 | 96.67 | 10.1 | 5.67 | 44 |
| 21 | Clin-K3 | 0.0958 | 96.89 | 10.1 | 5.64 | 44 |
| 22 (inventive) | Clin-NH1 | 0.0978 | 97.81 | 10.1 | 4.94 | 51 |
| 23 (inventive) | Clin-NH2 | 0.1035 | 97.05 | 10.1 | 3.74 | 63 |
| 24 (inventive) | Clin-NH3 | 0.1023 | 96.45 | 10.1 | 3.49 | 65 |
| 25 | Clin-C1 | 0.1011 | 96.99 | 10.1 | 9.27 | 8 |
| 26 | Clin-C0.5 | 0.1009 | 96.10 | 10.1 | 8.79 | 13 |
| 27 | Clin-C0.25 | 0.0988 | 95.44 | 10.1 | 7.76 | 23 |
| 28 | Clin-C0.13 | 0.0971 | 95.90 | 10.1 | 7.58 | 25 |

It can be gathered from the comparison of comparative Example 15 with inventive Examples 22-24 that the modified clinoptilolite zeolite attains a higher Cu removal than the untreated materials. A comparison of inventive Examples 22-24 with comparative Examples 19-21 and 25-28 prepared by other treatment protocols evidences a better performance of the inventive particulate mineral materials compared to the comparative particulate mineral materials comprising ion-exchange with other cations or acid treatments.

4.3 Pb Removal Experiments

Experiments were conducted to assess the performance of the natural and modified clinoptilolite in the removal of Pb. The results are provided in Table 5.

TABLE 5
Experimental details and results of Pb removal.

| | | m_{zeolite} | mₛₒₗᵤₜᵢₒₙ | cₛₜₐᵣₜ | c_{end} | Pb removal |
|---|---|---|---|---|---|---|
| Example | Zeolite | [g] | [g] | [mg/L] | [%] | [%] |
| 29 | Clin-P | — | 95.21 | 11.9 | 11.9 | 88.5 |
| 33 | Clin-K1 | 0.0519 | 96.52 | 11.9 | 0.138 | 98.4 |
| 34 | Clin-K2 | 0.0506 | 93.94 | 11.9 | 0.192 | 98.6 |
| 35 | Clin-K3 | 0.0520 | 93.31 | 11.9 | 0.169 | 98.4 |
| 36 (inventive) | Clin-NH1 | 0.0513 | 94.38 | 11.9 | 0.192 | 98.8 |
| 37 (inventive) | Clin-NH2 | 0.0507 | 93.92 | 11.9 | 0.141 | 98.8 |
| 38 (inventive) | Clin-NH3 | 0.0493 | 94.87 | 11.9 | 0.137 | 98.8 |
| 39 | Clin-C1 | 0.0498 | 98.31 | 11.9 | 0.138 | 35.6 |
| 40 | Clin-C0.5 | 0.0506 | 95.25 | 11.9 | 7.66 | 54.8 |
| 41 | Clin-C0.25 | 0.0520 | 94.99 | 11.9 | 5.38 | 76.5 |
| 42 | Clin-C0.13 | 0.0514 | 96.41 | 11.9 | 2.8 | 78.9 |

It can be gathered from the comparison of comparative Example 29 with inventive Examples 36-38 that the modified clinoptilolite zeolite attains a higher Pb removal than the untreated materials. A comparison of inventive Examples 36-38 with comparative Examples 33-35 and 39-42 prepared by other treatment protocols evidences a better performance of the inventive particulate mineral materials compared to the comparative particulate mineral materials comprising ion-exchange with other cations or acid treatments.

4.4 Zn Removal Experiments

Experiments were conducted to assess the performance of the natural and modified clinoptilolite in the removal of Zn. The results are provided in Table 6.

TABLE 6
Experimental details and results of Zn removal.

| | | | | | | Zn |
|---|---|---|---|---|---|---|
| | | m_{zeolite} | mₛₒₗᵤₜᵢₒₙ | cₛₜₐᵣₜ | c_{end} | removal |
| Example | Zeolite | [g] | [g] | [mg/L] | [%] | [%] |
| 43 | Clin-P | 0.1003 | 95.21 | 8.78 | 6.01 | 32 |
| 44 | Clin-Na1 | 0.1024 | 93.66 | 8.78 | 6.02 | 31 |
| 45 | Clin-Na2 | 0.0999 | 94.22 | 8.78 | 5.65 | 36 |
| 46 | Clin-Na3 | 0.0991 | 95.05 | 8.78 | 5.65 | 36 |
| 47 | Clin-K1 | 0.0980 | 95.62 | 8.78 | 6.44 | 27 |
| 48 | Clin-K2 | 0.1005 | 96.89 | 8.78 | 6.35 | 28 |
| 49 | Clin-K3 | 0.1021 | 96.81 | 8.78 | 6.21 | 29 |
| 50 (inventive) | Clin-NH1 | 0.1022 | 95.30 | 8.78 | 5.42 | 38 |
| 51 (inventive) | Clin-NH2 | 0.0976 | 93.93 | 8.78 | 5.16 | 41 |
| 52 (inventive) | Clin-NH3 | 0.1004 | 95.69 | 8.78 | 5.01 | 43 |
| 53 | Clin-C1 | 0.0961 | 95.54 | 8.78 | 8.77 | 0 |
| 54 | Clin-C0.5 | 0.0952 | 94.60 | 8.78 | 7.74 | 12 |
| 55 | Clin-C0.25 | 0.0997 | 97.52 | 8.78 | 7.06 | 20 |
| 56 | Clin-C0.13 | 0.0996 | 96.51 | 8.78 | 7.00 | 20 |

It can be gathered from the comparison of comparative Example 43 with inventive Example 50-52 that the modified clinoptilolite zeolite attains a higher Zn removal than the untreated materials. A comparison of inventive Examples 50-52 with comparative Examples 44-49 and 53-56 prepared by other treatment protocols evidences a better performance of the inventive particulate mineral materials compared to the comparative particulate mineral materials comprising ion-exchange with other cations or acid treatments.

4.5 Hg Removal Experiments

Experiments were conducted to assess the performance of the natural and modified clinoptilolite in the removal of Hg. The results are provided in Table 7.

TABLE 7
Experimental details and results of Hg removal.

| | | | | | | Hg |
|---|---|---|---|---|---|---|
| | | m_{zeolite} | mₛₒₗᵤₜᵢₒₙ | cₛₜₐᵣₜ | c_{end} | removal |
| Example | Zeolite | [g] | [g] | [mg/L] | [%] | [%] |
| 57 | Clin-P | 0.0820 | 42.56 | 1.00^{a} | 0.306 | 69 |
| 58 | Clin-Na1 | 0.0810 | 42.02 | 1.00^{a} | 0.751 | 25 |
| 59 | Clin-Na2 | 0.0825 | 42.26 | 1.00^{a} | 0.832 | 17 |
| 60 | Clin-Na3 | 0.0802 | 40.40 | 1.00^{a} | 0.742 | 26 |
| 61 | Clin-K1 | 0.0816 | 40.09 | 1.00^{a} | 0.482 | 52 |
| 62 | Clin-K2 | 0.0809 | 42.04 | 1.00^{a} | 0.732 | 27 |
| 63 | Clin-K3 | 0.0812 | 39.41 | 1.00^{a} | 0.729 | 27 |
| 64 (inventive) | Clin-NH1 | 0.0809 | 40.10 | 1.00^{a} | 0.001 | 99.9 |
| 65 (inventive) | Clin-NH2 | 0.0812 | 40.33 | 1.00^{a} | 0.001 | 99.9 |
| 66 (inventive) | Clin-NH3 | 0.0803 | 43.27 | 1.00^{a} | 0.001 | 99.9 |
| 67 | Clin-C1 | 0.0809 | 40.10 | 1.00^{a} | 0.848 | 15 |
| 68 | Clin-C0.5 | 0.0803 | 40.69 | 1.00^{a} | 0.821 | 18 |
| 69 | Clin-C0.25 | 0.0796 | 42.21 | 1.00^{a} | 0.757 | 24 |
| 70 | Clin-C0.13 | 0.0826 | 40.50 | 1.00^{a} | 0.777 | 22 |

^{a}calculated starting concentration based on weigh-in.

It can be gathered from the comparison of comparative Example 57 with inventive Examples 64-66 that the modified clinoptilolite zeolite attains a higher Hg removal than the untreated materials. A comparison of the inventive Examples 64-66 with comparative Examples 58-63 and 67-70 prepared by other treatment protocols evidences a better performance of the inventive particulate mineral materials compared to the comparative particulate mineral materials comprising ion-exchange with other cations or acid treatments.

4.6 Ammonium Removal Experiments (Comparative Examples)

Experiments were conducted to assess the performance of the natural and modified clinoptilolite in the removal of ammonium. The results are provided in Table 8.

TABLE 8
Experimental details and results of ammonium removal.

| | | m_{zeolite} | mₛₒₗᵤₜᵢₒₙ | cₛₜₐᵣₜ | c_{end} | Hg removal |
|---|---|---|---|---|---|---|
| Example | Zeolite | [g] | [g] | [mg/L] | [%] | [%] |
| 71 | Clin-P | 0.0982 | 97.03 | 20.00 | 14.70 | 27 |
| 72 | Clin-Na1 | 0.1017 | 95.78 | 20.00 | 12.30 | 39 |
| 73 | Clin-Na2 | 0.1018 | 94.89 | 20.00 | 10.80 | 46 |
| 74 | Clin-Na3 | 0.1003 | 95.25 | 20.00 | 10.70 | 47 |
| 75 | Clin-K1 | 0.1016 | 93.34 | 20.00 | 13.80 | 31 |
| 76 | Clin-K2 | 0.1021 | 94.48 | 20.00 | 14.00 | 30 |
| 77 | Clin-K3 | 0.0994 | 96.44 | 20.00 | 14.00 | 30 |
| 78 | Clin-NH1 | 0.1019 | 94.51 | 20.00 | 18.90 | 6 |
| 79 | Clin-NH2 | 0.1012 | 97.83 | 20.00 | 20.70 | −4^{a} |
| 80 | Clin-NH3 | 0.0952 | 93.85 | 20.00 | 21.10 | −6^{a} |
| 81 | Clin-C1 | 0.1008 | 96.63 | 20.00 | 16.40 | 18 |
| 82 | Clin-C0.5 | 0.1016 | 93.15 | 20.00 | 15.20 | 24 |
| 83 | Clin-C0.25 | 0.1009 | 94.78 | 20.00 | 6.42 | 68 |
| 84 | Clin-C0.13 | 0.1007 | 96.28 | 20.00 | 14.90 | 26 |

It can be gathered from the comparison of Example 71 with Examples 78-80 that the modified clinoptilolite zeolite attains a reduced performance compared to the untreated material. In contrast, the other treatment protocols evidence a better performance, particularly the samples ion-exchanged with NaCl (Examples 72-74), and the HCl-treated samples (Examples 81-84).

### 5. Conclusions

It can be gathered from the above data that the modified natural heulandite zeolites described in this document consistently attain an improved performance in the removal of heavy metals from a liquid medium. Furthermore, Examples 64 to 66 show that the inventive particulate mineral material provides an outstanding performance in the removal of mercury cations.

1-12. (canceled)

13. A method for removing heavy metal cations from a liquid medium comprising the steps of:
a) providing a liquid medium containing heavy metal cations,
b) providing particulate mineral material comprising modified heulandite group zeolite, wherein at least a part of the exchangeable cations in the heulandite group zeolite is replaced by ammonium cations,
c) contacting the particulate mineral material of step b) with the liquid medium of step a) to remove heavy metal cations from the liquid medium by forming a heavy metal loaded particulate mineral material.

14. The method of claim 13, wherein the particulate mineral material of step b) is prepared by a method comprising the steps of:
i) providing a particulate heulandite group zeolite source material, wherein the heulandite group zeolite comprises exchangeable cations,
ii) providing an aqueous solution comprising at least one water-soluble ammonium salt,
iii) treating the particulate heulandite group zeolite source material of step i) with the aqueous solution of step ii) to form particulate mineral material comprising modified heulandite group zeolite, wherein at least a part of the exchangeable cations in the heulandite group zeolite is replaced by the ammonium cations of the water-soluble ammonium salt.

15. The method of claim 14, wherein the at least one water-soluble ammonium salt of step ii) is selected from ammonium nitrate, ammonium chloride, ammonium bromide, ammonium iodide, ammonium perchlorate, ammonium hydroxide, ammonium carbonate, ammonium sulfate, ammonium phosphate, or mixtures thereof, preferably the at least one water-soluble ammonium salt is ammonium nitrate.

16. The method of claim 14, wherein the at least one water-soluble ammonium salt of step ii) is provided in an amount so that the amount of ammonium cations in the water-soluble ammonium salt is from 0.05 to 20 wt.-%, based on the total weight of the particulate mineral material, preferably in an amount from 0.25 to 7.5 wt.-%, more preferably in an amount from 0.5 to 4 wt.-%, and most preferably in an amount from 1 to 3 wt.-%.

17. The method of claim 14, wherein the aqueous solution comprising the at least one water-soluble ammonium salt of step ii) has an ammonium cation concentration from 0.001 to 20 mol/1, preferably from 0.01 to 15 mol/1, more preferably from 1 to 7.5 mol/1, and most preferably from 2 to 5 mol/1.

18. The method of claim 13, wherein the method further comprises a step d) of removing the heavy metal loaded particulate mineral material from the liquid medium after step c), preferably step d) is performed by filtration, centrifugation, sedimentation, or flotation.

19. The method of claim 13, wherein the method is performed in a system for removing heavy metal cations from a liquid medium comprising a reactor, wherein the reactor comprises an inlet for the liquid medium containing heavy metal cations, the particulate mineral material comprising modified heulandite group zeolite, and an outlet for heavy metal cation depleted liquid medium.

20. A system for removing heavy metal cations from a liquid medium comprising a reactor, wherein the reactor comprises
an inlet for a liquid medium containing heavy metal cations,
particulate mineral material comprising modified heulandite group zeolite, wherein at least a part of the exchangeable cations in the heulandite group zeolite is replaced by ammonium cations, and
an outlet for heavy metal cation depleted liquid medium.

21. The system of claim 20, wherein the reactor contains the particulate mineral material in form of pellets and/or the particulate mineral material is provided in form of a bed or column.

22. The method of claim 14, wherein at least 70% of the exchangeable cations in the heulandite group zeolite are replaced by ammonium cations, preferably at least 90% of the exchangeable cations in the heulandite group zeolite are replaced by ammonium cations, more preferably at least 95% of the exchangeable cations in the heulandite group zeolite are replaced by ammonium cations, and most preferably all exchangeable cations in the heulandite group zeolite are replaced by ammonium cations.

23. The method of claim 13, wherein the heulandite group zeolite is clinoptilolite.

24. The method of claim 13, wherein the particulate mineral material has a weight median particle size d50 from 0.05 to 500 μm, preferably from 0.2 to 200 μm, more preferably from 0.4 to 100 μm, and most preferably from 0.6 to 20 μm, and/or a weight top cut particle size d98 from 0.15 to 1500 μm, preferably from 1 to 600 μm, more preferably from 1.5 to 300 μm, and most preferably from 2 to 80 μm.

25. The method of claim 13, wherein the surface of the particulate mineral material is free of halogen compounds, preferably free of halogen compounds selected from the group consisting of chlorides, chlorates, hypochlorites, bromides, bromates, hypobromites, iodides, iodates, hypoiodites, and mixtures thereof, and most preferably free of halogen compounds selected from the group consisting of bromine, chlorine, iodine, sodium bromide, calcium bromide, magnesium bromide, copper (II) bromide, iron (II) bromide, iron (III) bromide, zinc bromide, potassium bromide, copper (I) chloride, copper (II) chloride, iron (II) chloride, iron (III) chloride, zinc chloride, calcium hypochlorite, calcium hypobromite, calcium hypoiodite, calcium chloride, calcium iodide, magnesium chloride, magnesium iodide, sodium chloride, sodium iodide, potassium tri-chloride, potassium tri-bromide, potassium tri-iodide, or mixtures thereof.

26. The method of claim 13, wherein the particulate mineral material has a specific surface area of from 5 m2/g to 200 m2/g, preferably from 10 m2/g to 180 m2/g, more preferably from 20 m2/g to 170 m2/g, even more preferably from 25 m2/g to 150 m2/g, and most preferably from 30 m2/g to 120 m2/g, measured using nitrogen sorption and the BET method.

27. The method of claim 13, wherein the heavy metal cations are selected from the group consisting of arsenic, cadmium, chromium, cobalt, copper, gold, iron, lead, manganese, mercury, molybdenum, nickel, silver, tin, zinc, or mixtures thereof, preferably the heavy metal cations are selected from the group consisting of cadmium, copper, lead, mercury, zinc, or mixtures thereof, more preferably the heavy metal cations are selected from the group consisting of copper, lead, mercury, or mixtures thereof, and most preferably the heavy metal cations are mercury cations.

28. The system of claim 20, wherein the liquid medium is an aqueous medium, preferably the aqueous medium is selected from process water, sewage water, waste water, preferably waste water from the paper industry, waste water from the colour-, paints-, or coatings industry, waste water from breweries, waste water from the leather industry, agricultural waste water, slaughterhouse waste water, process or waste water from power plants, waste water from waste incineration, waste water from mercury recycling, waste water from cement production, waste water from steel production, waste water from production of fossil fuels, from sludge, preferably sewage sludge, harbour sludge, river sludge, coastal sludge, digested sludge, mining sludge, municipal sludge, civil engineering sludge, sludge from oil drilling or the effluents the aforementioned dewatered sludges.

29. The system of claim 20, wherein at least 70% of the exchangeable cations in the heulandite group zeolite are replaced by ammonium cations, preferably at least 90% of the exchangeable cations in the heulandite group zeolite are replaced by ammonium cations, more preferably at least 95% of the exchangeable cations in the heulandite group zeolite are replaced by ammonium cations, and most preferably all exchangeable cations in the heulandite group zeolite are replaced by ammonium cations.

30. The system of claim 20, wherein the particulate mineral material has a weight median particle size d50 from 0.05 to 500 μm, preferably from 0.2 to 200 μm, more preferably from 0.4 to 100 μm, and most preferably from 0.6 to 20 μm, and/or a weight top cut particle size d98 from 0.15 to 1500 μm, preferably from 1 to 600 μm, more preferably from 1.5 to 300 μm, and most preferably from 2 to 80 μm.

31. The system of claim 20, wherein the particulate mineral material has a specific surface area of from 5 m2/g to 200 m2/g, preferably from 10 m2/g to 180 m2/g, more preferably from 20 m2/g to 170 m2/g, even more preferably from 25 m2/g to 150 m2/g, and most preferably from 30 m2/g to 120 m2/g, measured using nitrogen sorption and the BET method.

32. The system of claim 20, wherein the heavy metal cations are selected from the group consisting of arsenic, cadmium, chromium, cobalt, copper, gold, iron, lead, manganese, mercury, molybdenum, nickel, silver, tin, zinc, or mixtures thereof, preferably the heavy metal cations are selected from the group consisting of cadmium, copper, lead, mercury, zinc, or mixtures thereof, more preferably the heavy metal cations are selected from the group consisting of copper, lead, mercury, or mixtures thereof, and most preferably the heavy
